(19) United States
(12) Patent Application Publication
(10) Pub. No.: US 2018/0145514 A1
(43) Pub. Date: May 24, 2018

(54) PREDICTIVE BATTERY CHARGE AND DISCHARGE ANALYSIS

(71) Applicant: Microsoft Technology Licensing, LLC, Redmond, WA (US)

(72) Inventors: Sandeep Robert Prabhakar, Bellevue, WA (US); lulian D. Calinov, Sammamish, WA (US); Javier N. Flores Assad, Bothell, WA (US); Jihad Tafas, Redmond, WA (US)

(21) Appl. No.: 15/357,325

(22) Filed: Nov. 21, 2016

(51) Int. Cl. H02J 7/00

(52) U.S. Cl. CPC H02J 7/007; H02J 2007/0096

(57) ABSTRACT

Determining a charge time or a discharge time for a battery of a device. One or more historical data items that correspond to historical usage of the device that is powered by the battery are identified. One or more current state data items that correspond to at least one current state of the device are also identified. One or more future intent data items that are associated with at least one future action that a user of the device may perform are also identified. A charge time or a discharge time for the battery is also determined. The determination is based on a combination of the one or more historical data items, the one or more current state data items, and the one or more future intent data items. Either the determined charge time for the battery or the determined discharge time for the battery is then outputted.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been, and are being, developed in all shapes and sizes with varying capabilities. As such, many individuals and families alike have begun using multiple computer systems throughout a given day.

For instance, an individual may perform simple computing tasks such as email, handwritten notes, and so forth on a tablet or smartphone, while performing more intensive computing tasks on a laptop or desktop computer system. While the capabilities of such computer systems have seen dramatic improvements recently, oftentimes the batteries that power such devices have not seen the same improvement. Additionally, with so many computer systems (e.g., laptop, tablet, smartphone, smartwatch, and so forth) that can be used throughout a given day, it can be difficult to keep track of the battery power remaining for each device.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to determining a charge time or a discharge time for a battery of a device. For example, embodiments may include identifying one or more historical data items that correspond to historical usage of the device that is powered by the battery. One or more current state data items that correspond to at least one current state of the device may also be identified. Additionally, one or more future intent data items that are associated with at least one future action that a user of the device may perform may be identified. A charge time or a discharge time for the battery may also be determined. The determination may be based on a combination of the one or more historical data items, the one or more current state data items, and the one or more future intent data items. Once the determination is made, either the determined charge time for the battery or the determined discharge time for the battery may be outputted.

Accordingly, battery charge times and battery discharge times for a battery of a computer system may be more accurately and usefully determined/predicted by considering a combination of current state data of the computer system, historic usage data of the computer system, future intent data of a user of the computer system, environmental data associated with the user/computer system, and historical usage data associated with other computer systems that are similar to the computer system. Additionally, such data may also be used to determine suggested actions that a user can take to improve any given battery situation. Notably, a specific improvement that will occur in response to performing the suggested action may also be determined and outputted to the user such that the user can decide whether the improvement is worth taking the suggested action.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates an example environment for determining battery time remaining for charging or discharging a battery.

FIG. 3 illustrates a table for identifying current state data items.

FIG. 4 illustrates a table for identifying historical usage data items relating to particular dates and times.

FIG. 5 illustrates a flow chart of an example method for determining battery time remaining for charging or discharging a battery.

### DETAILED DESCRIPTION

At least some embodiments described herein relate to determining a charge time or a discharge time for a battery of a device. For example, embodiments may include identifying one or more historical data items that correspond to historical usage of the device that is powered by the battery. One or more current state data items that correspond to at least one current state of the device may also be identified. Additionally, one or more future intent data items that are associated with at least one future action that a user of the device may perform may be identified. A charge time or a discharge time for the battery may also be determined. The determination may be based on a combination of the one or more historical data items, the one or more current state data items, and the one or more future intent data items. Once the determination is made, either the determined charge time for the battery or the determined discharge time for the battery may be outputted.

Accordingly, battery charge times and battery discharge times for a battery of a computer system may be more accurately and usefully determined/predicted by considering a combination of current state data of the computer system, historic usage data of the computer system, future intent data of a user of the computer system, environmental data associated with the user/computer system, and historical usage data associated with other computer systems that are similar to the computer system. Additionally, such data may also be used to determine suggested actions that a user can take to improve any given battery situation. Notably, a specific improvement that will occur in response to performing the suggested action may also be determined and outputted to the user such that the user can decide whether the improvement is worth taking the suggested action.

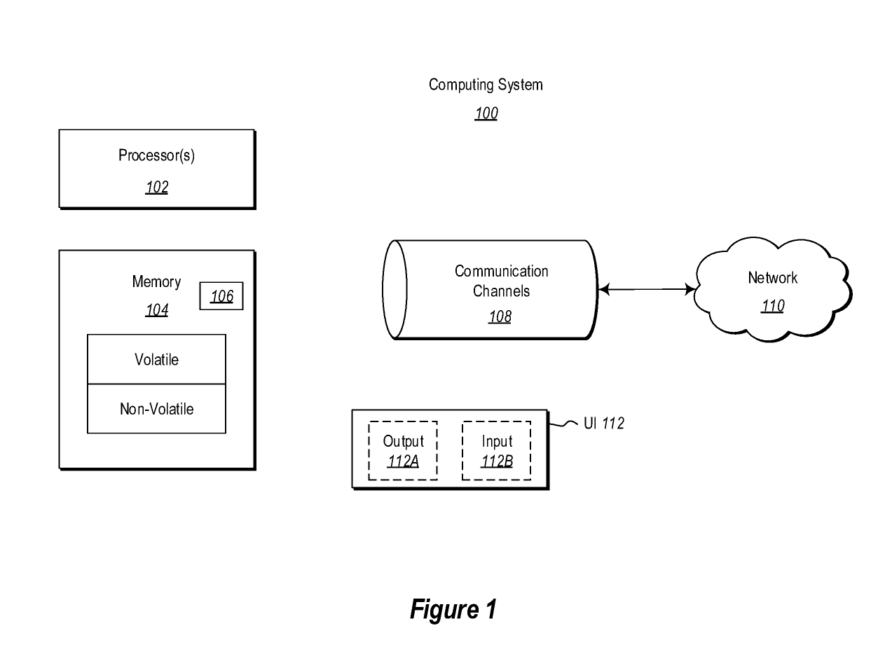

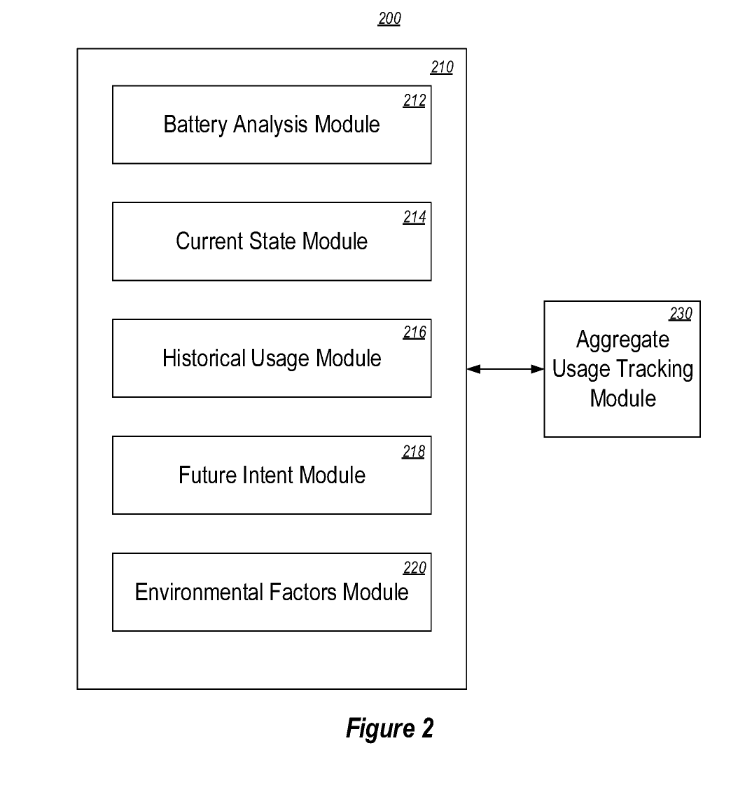

Some introductory discussion of a computing system will be described with respect to FIG. 1. Then determining a battery charge or a battery discharge time, and suggested actions a user may take to improve the determined battery charge or the battery discharge time will be described with respect to FIGS. 2 through 5.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates an example environment for determining battery time remaining for charging or discharging a battery. As illustrated, FIG. 2 includes a computer system 200 that may be similar to the computer system 100, as described in FIG. 1. Computer system 200 may comprise any type of mobile or desktop computer system that currently exists or may exist in the future (e.g., desktop computer, laptop, tablet, smartphone, smartwatch, and so forth). Additionally, computer system 200 may run any type of desktop or mobile operating system that is currently available or yet to be developed (e.g., MICROSOFT® WINDOWS®, APPLE® MACOS™, APPLE IOS®, GOOGLE™ CHROME OS™, GOOGLE ANDROID™, and so forth).

As shown, computer system 200 includes a battery analysis module 212, a current state module 214, a historical module 216, a future intent module 218, and an environmental factors module 220. Battery analysis module 212 may comprise any combination of applicable hardware and software that can determine a discharge time and a charge time of a battery of computer system 200. In other words, battery analysis module 212 may be capable of determining how long before a remaining capacity of the battery is drained when the computer system is either not connected to an external power source (i.e., discharge time) or connected to a power source that is currently incapable of charging the battery (e.g., the battery is being discharged faster than it can charge). Similarly, the battery analysis module may also be capable of determining how long before the battery is charged when the computer system is connected to an external power source that is capable of charging the battery (i.e., charge time). As part of the discharge time and charge time determinations, the battery analysis module may consider any combination of one or more current states/settings of the computer system, historical usage of the computer system, likely future use of the computer system (or future user intent with respect to the computer system), and environmental factors, as described more fully herein.

FIG. 2 also includes current state module 214. Current state module 214 may comprise any combination of hardware and software that can identify/track any number of current states of computer system 200. Current state tracking, as further described herein, may later be used by the battery analysis module to determine both charge and discharge times associated with a computer system's battery, as well as suggest appropriate actions that a user may take to improve the battery charge and discharge times.

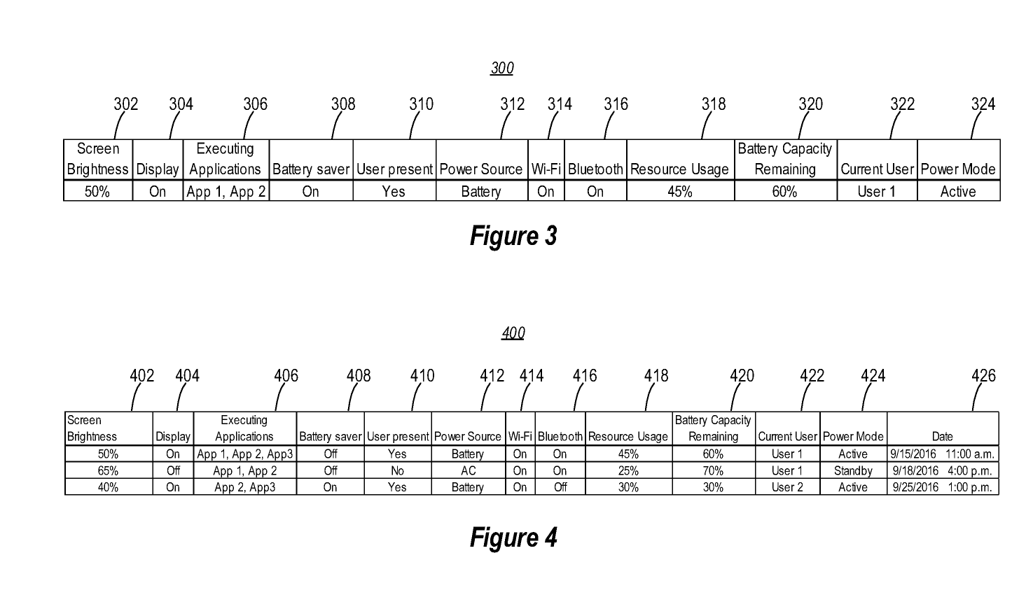

For example, the current state module may track any combination of states/settings of the computer system 210. For example, as shown in the table of FIG. 3, states/settings may be recorded in a table that includes a current screen brightness of a display of the computer system (column 302), whether the computer system's display is currently on or off (column 304), which particular application(s) are currently executing within the computer system (column 306), whether a battery saver mode is currently being utilized by the computer system (column 308), whether a user is currently present at the computer system (column 310), whether the current power source of the computer system is the battery or another power source (e.g., AC power source) (column 312), whether Wi-Fi® is on (column 314), whether BLUETOOTH® is on (column 316), current usage of processing/memory resources (column 318), a current battery capacity remaining (column 320), a current user of the computer system (column 322), a power mode of the computer system (column 324), and so forth. While the foregoing computer system states are discussed herein, there may be any number of other applicable computer system states that come within the scope of the present disclosure. Similarly, while the computer system states of FIG. 3 are shown as being recorded in a table, such data may be recorded in any appropriate data structure.

As illustrated, FIG. 2 also includes historical usage module 216. Historical usage module 216 may comprise any combination of hardware and software that can track/identify historical usage of the computer system 200. Historical usage tracking, as further described herein, may later be used by the battery analysis module to determine both charge and discharge times associated with a computer system's battery, as well as suggest appropriate actions that a user may take to improve the battery charge and discharge times.

In some embodiments, the historical usage module may track historical usage data of a computer system according to the historical usage of each particular user of the computer system (i.e., in cases where more than one user uses the particular computer system). In other words, the historical usage module may track historical usage data that is separate and distinct for each particular user of a computer system. In other embodiments, historical usage data of the computer system may not consider the particular user(s).

The historical usage module may track not only how the computer system was used, but when (e.g., time of day, day of the week, and so forth) the computer system was used in particular ways, and how the charge and discharge times of the computer system's battery were affected by the particular ways in which the computer system was used. Additionally, the historical usage module may identify patterns of computer usage. For instance, a user of computer system 210 may use a video conferencing application every Tuesday at 1:00 p.m., which pattern may be identified by the historical usage module, and later used by the battery analysis module (as well as the future intent module).

Tracking/identification of historical usage may also include the same, or similar, items discussed with respect to the current state module 214. As shown in the data table 400 of FIG. 4, with respect to the time (e.g., time of day, day of week, and so forth) and/or how charge/discharge times were affected, the historical usage module may track/identify factors (or states) such as a screen brightness of a display of the computer system (column 402), whether the computer system's display was on or off (column 404), which particular application(s) were executing within the computer system (column 406), whether a battery saver mode was being utilized by the computer system (column 408), whether a user was present at the computer system (column 410), whether the power source of the computer system was the battery or another power source (e.g., AC power source) (column 412), whether Wi-Fi was on (column 414), whether BLUETOOTH was on (column 416), usage of processing/memory resources (column 418), a battery capacity remaining (column 320), a user of the computer system at the time (column 322), a power mode of the computer system (column 324), the date and time on which the particular states/settings were identified, and so forth.

While the foregoing computer system states are discussed herein, there may be any number of other applicable computer system states that come within the scope of the present disclosure. Similarly, while the computer system states of FIG. 4 are shown as being recorded in a table, such data may be recorded in any appropriate data structure. Additionally, while settings/states were only recorded with respect to three dates and times, there may be any number of recorded data items relating historical usage states/settings. For instance, states/settings may be identified and recorded in particular time intervals. As an example, states/settings may be identified and recorded every 10 minutes, every 15 minutes, every 30 minutes, every hour, every two hours, every 5 hours, once a day, twice a day, and so forth.

As briefly described, such tracking may be performed with respect to each individual user of the computer system or as an overall historical usage of the computer system regardless of the number of users or particular user at any given time. Additionally, the historical usage module may track these factors separately for how a given battery's discharge time is affected by the described factors versus how the given battery's charge time is affected by the described factors. For example, the historical usage module may have a discharge database corresponding to the described factors when the battery is discharging, and a separate charge database corresponding to the described factors when the battery is charging.

FIG. 2 also includes future intent module 218. Future intent module 218 may comprise any combination of hardware and software that can track/identify future possible usage of the computer system. Future intent tracking, as further described herein, may later be used by the battery analysis module to determine both charge and discharge times associated with a computer system's battery, as well as suggest appropriate actions that a user may take to improve the battery charge and discharge times.

For instance, the future intent module 218 may track what a user intends to do in the near future (e.g., the coming minutes, hours, days, and so forth). In a more specific example, the future intent module may track a user's calendar such that the future intent module can identify how the user may intend to use the computer in the near future. For instance, a user may have scheduled a video conference, a flight, a business meeting, and so forth for a particular day and/or time. The future intent module may also track patterns of a user's ordinary actions throughout a day. For example, a user of the computer system 210 may generally drive through rush hour traffic on the way to work, arriving at work during a particular time range (e.g., between 7:30 a.m. and 8:00 a.m.). As such, the future intent module may track such actions and determine when a user is likely to perform such actions.

In some embodiments, the future intent module may be able to access the historical usage module to determine such usage patterns. For example, a user of computer system 210 may generally have a video conference every Monday at a particular time. As such, the future intent module may determine that the user is likely to continue to perform video conferences every Monday at the particular time. While identifying such patterns are discussed as being the responsibility of the future intent module, the battery analysis module, the historical usage module, and the environmental factors module may also be involved in such pattern identification.

FIG. 2 also includes environmental factors module 220. Environmental factors module 220 may comprise any combination of hardware and software that can track/identify environmental factors associated with the computer system. Environmental factors tracking, as further described herein, may later be used by the battery analysis module to determine both charge and discharge times associated with a computer system's battery, as well as suggest appropriate actions that a user may take to improve the battery charge and discharge times. For instance, the environmental factors module may identify a current time of year, a current location of the device, a likely future location of the device, a time of sunrise, a time of sunset, current weather, a near future weather forecast, current traffic, likely near future traffic, delayed transportation (e.g., delayed flight, train, and so forth), and so forth.

As illustrated, FIG. 2 also includes an aggregate usage tracking service 230 that tracks the historical usage of computer systems having capabilities (e.g., hardware and software capabilities, including processing capabilities, operating system capabilities, and so forth) that are similar to, or the same as, computer system 210. For instance, the aggregate usage tracking service may track how charge/discharge times were affected by factors such as a screen brightness state of a display of the computer system, whether the computer system's display was on or off, which particular application(s) executed within the computer system, a system state of the computer system, whether a battery saver mode was being utilized by the computer system, whether a user was currently present at the computer system, whether the power source of the computer system was the battery or connected to another power source, a power mode of the computer system, a usage of processing/memory resources, battery capacity remaining, a battery drain rate, and so forth.

Furthermore, aggregate usage tracking service 230 may also perform analyses on tracked data such that battery analysis module 212 may utilize such analyses when determining charge/discharge times and/or suggested user actions, as described more fully herein. In some embodiments, the aggregate usage tracking service may comprise a cloud computing service or database that is accessible to the computer system 210 (and ultimately the battery analysis module 212).

Battery analysis module 212 may then be able to access/gather all of the data tracked/identified by the current state module, historical module, future intent module, environmental factor module, and aggregate usage tracking service to determine both charge/discharge times for a given battery, as well as suggested actions a user can take to improve the determined charge/discharge times. In some embodiments, the battery analysis module may consider at least one data item from each of the described modules/services in order to determine either or both of a charge or discharge time relating to a particular battery, and suggested actions that a user may take to improve determined charge or discharge times. In other embodiments, the battery analysis module may use any combination of data from any combination of the described modules.

In an example relating to accessing (by the battery analysis module) data gathered by the current state module, the battery analysis module may analyze any combination of data items relating to the current states/settings of the computer system 210 (e.g., the current screen brightness, the current percentage of battery power remaining, whether the computer system is currently in a battery saver mode, and so forth), as well as any combination of data items tracked by the other described modules/services in order to determine either a discharge time (e.g., the computer system is not currently connected to an external power source), or a charge time (e.g., the computer system is currently connected to an external power source that is charging the battery). Once a determination of the charge/discharge time of the battery has been made, the battery analysis module may output to the user the determined time (e.g., 50 minutes until the battery is fully charged or two hours until the battery is fully discharged).

Furthermore, the battery analysis module may use data from the current state settings in order dynamically update the determined charge/discharge time. As such, each time a user changes a state/setting of the computer system, the battery analysis module may immediately factor that changed setting the charge/discharge time determination. In an example, when a user changes the screen brightness, the battery analysis module may immediately consider how the changed screen brightness may affect the charge/discharge time of the battery.

Additionally, when a user has changed a setting, the battery analysis module may immediately determine and output how the battery charge/discharge time has been affected. For instance, when a user changes from a regular operating mode to a battery saver mode, the battery analysis module may determine and output the amount of time gained or lost in terms of charge/discharge times by taking such an action. Accordingly, a user may be able to immediately consider the effect their actions take on charge/discharge times and make an educated decision regarding how to respond (e.g., whether using a battery saver mode that decreases performance in worth the gain in battery charge/discharge time).

In some embodiments, particular current state data may be weighted such that some factors are more important in the charge/discharge time determination than others. For instance, the percentage of computer system resources currently being used may be weighted as more important than the current screen brightness. In some embodiments, such weighting may be determined based on analyses performed by any combination of the current state module, historical usage module, aggregate usage tracking service, or battery analysis module using historical usage data of what factors have had the biggest impact on battery charge/discharge times of the computer system 210 (and/or other similar computer systems, as tracked by the aggregate usage tracking service).

In an example relating to accessing (by the battery analysis module) data gathered by the historical usage module, the battery analysis module may analyze any combination of historical usage data along with any combination of data tracked by the other described modules/services in order to determine either a discharge time or a charge time. For instance, such states/settings may include any of the states/settings described herein (as well as others that would be known to one of skill in the art), including the current screen brightness, the current percentage of battery power remaining, whether the computer system is currently in a battery saver mode, and a percentage of computer system resources currently being used. Once the charge/discharge time has been determined, the battery analysis module may output the determined time to the user.

In some embodiments, historical usage data gathered by the historical usage module may be weighted by the battery analysis module (or may be previously weighted by the historical usage module). For instance, historical usage data may be weighted based on how long ago the data was recorded. In such cases, historical usage data that is associated with more recent historical usage may be weighted more heavily (e.g., have a higher level of importance in determining charge/discharge times) than historical usage data that is associated with older historical usage. Such weighting may occur in any number of ways including logarithmic weighting (i.e., the older the recorded data, the closer the data is weighted to zero). In another example, historical data that occurred past a certain threshold in time may no longer be considered (e.g., more than a month, more than six months, more than a year, and so forth). While these are only two examples, weighting may occur in any appropriate way that would be understood by one of skill in the art.

In an example relating to accessing (by the battery analysis module) data gathered by the future intent module, the battery analysis module may analyze any combination of the data tracked by the future intent module regarding what a user of the computer system intends to do in the near future along with any combination of data tracked by the other described modules/services in order to determine either a discharge time or a charge time. For instance, the battery analysis module may use data gathered from a user's calendar regarding what the user intends to do in the near future, data relating to identified patterns of computer usage/daily routines associated with the user (e.g., the user uses a map application to see what his/her commute looks like each day around 5:00 p.m., the user commutes around 8:00 a.m. and 5:30 p.m. each day, and so forth), historical usage data and current state data (e.g., the current battery capacity remaining) in order to more accurately predict/determine and output a battery charge/discharge time.

In an example relating to accessing (by the battery analysis module) data gathered by the environmental factors module, the battery analysis module may analyze any combination of data tracked by the other modules/services, as well as current or near-future environmental factors in order to determine either a discharge time or a charge time. For instance, the battery analysis module may access data from the environmental factors module that indicates that the current time of year is winter and as such, sunrise occurs relatively late while sunset occurs relatively early. As such, the environmental factors module (and/or the battery analysis module) may determine that the late sunrise and early sunset will likely cause the user to use a lower/dimmer screen brightness setting as less sunlight is likely to enter the user's home or office. Accordingly, the battery analysis module may use such data in combination with any other data from the other modules/services to more accurately predict/determine the charge/discharge time and output the determined charge/discharge time to the user.

In an example relating to accessing (by the battery analysis module) data gathered by the aggregate usage tracking service, the battery analysis module may analyze a combination of the historical usage of computer systems/batteries other than the computer system 210 (and the battery of computer system 210) that were gathered by the aggregate usage tracking service along with any number of data items from any number of the other described modules. In some embodiments, the data items gathered by the aggregate usage tracking service may be weighted less heavily than the data items that relate directly to computer system 210 (e.g., data gathered by the historical usage module).

In some embodiments, data may be weighted based on a data type of data tracked. For instance, future intent data may be weighted as less important than historical usage data because the future intent data is more predictive (and potentially less reliable) in nature than the historical usage data. In another example, certain future intent data may be deemed more reliable than other future intent data and may thus be given more weight. In a more specific example, identified calendar items may be more reliable than particular identified patterns of usage that the user is predicted to perform. As such, the identified calendar items would be given more weight than identified patterns of usage. In other embodiments, however, tracked data may not be weighted based on data type.

Once a charge/discharge time has been determined using any number of data items from any number of the described modules/services, the battery analysis module may suggest actions a user can take to improve any given battery situation. For instance, the battery analysis module may suggest that a user turn on a battery saver mode (i.e., a mode that uses less computer resources—dimmer screen brightness, less background processes, and so forth) of the computer system in order to either discharge the battery capacity remaining more slowly or to charge the battery capacity remaining more quickly. In another example, the battery analysis module may suggest that a user change one or more settings/states of the computer system, including dimming screen brightness, changing a power mode, killing background processes, and so forth.

In a specific example, the battery analysis module may utilize any number of data items provided by any number of the described modules/services to determine both that the battery discharge time of the computer system is 3 hours, while the user has an upcoming flight of five hours, during which the user may not be able to charge the battery of the computer system. As such, the battery analysis module may suggest that the user begin charging the battery of the computer system in order to have enough battery capacity remaining to last through the five-hour flight. Notably, the battery analysis module may suggest actions in any applicable manner. For instance, the battery analysis module may audibly suggest one or more actions, display one or more suggest actions on a display of the computer system, both display and audibly produce the suggest, and so forth.

Additionally, the battery analysis module may output the improvement in charge/discharge time that will occur if the user performs a suggested action. For example, the battery analysis module may suggest to dim screen brightness by a particular percentage and output an associated charge/discharge time improvement associated with dimming the screen brightness (e.g., dimming the screen by the suggested amount will result in 30 more minutes of battery discharge time). Accordingly, a user may utilize the outputted charge/discharge time improvement associated with taking a suggested action to determine whether performing the suggested action is worth performing (e.g., the decrease in performance is worth the increase in battery charge time or decrease in battery discharge time).

In some embodiments, the battery analysis module 212 may also utilize a smart assistant (e.g., MICROSOFT CORTANA®, APPLE SIRI®, GOOGLE ASSISTANT, AMAZON® ALEXA™, and so forth) for both making determinations of charge/discharge times, as well as to communicate suggested actions the user can take to improve the determined charge/discharge times. Similarly, any of the described modules/services may use a smart assistant for gathering/identifying data. For instance, the future intent module may use a smart assistant to identify data within a calendar of a user. In another example, MICROSOFT CORTANA could audibly alert a user that the user could begin charging a battery associated with the user's device in order to have enough battery for an upcoming meeting, flight, commute, and so forth. Additionally, each of the modules/services described may use machine learning/artificial intelligence to continually improve the way in which data is tracked and analyzed in order to determine the most accurate and useful battery charge/discharge times and/or suggest actions.

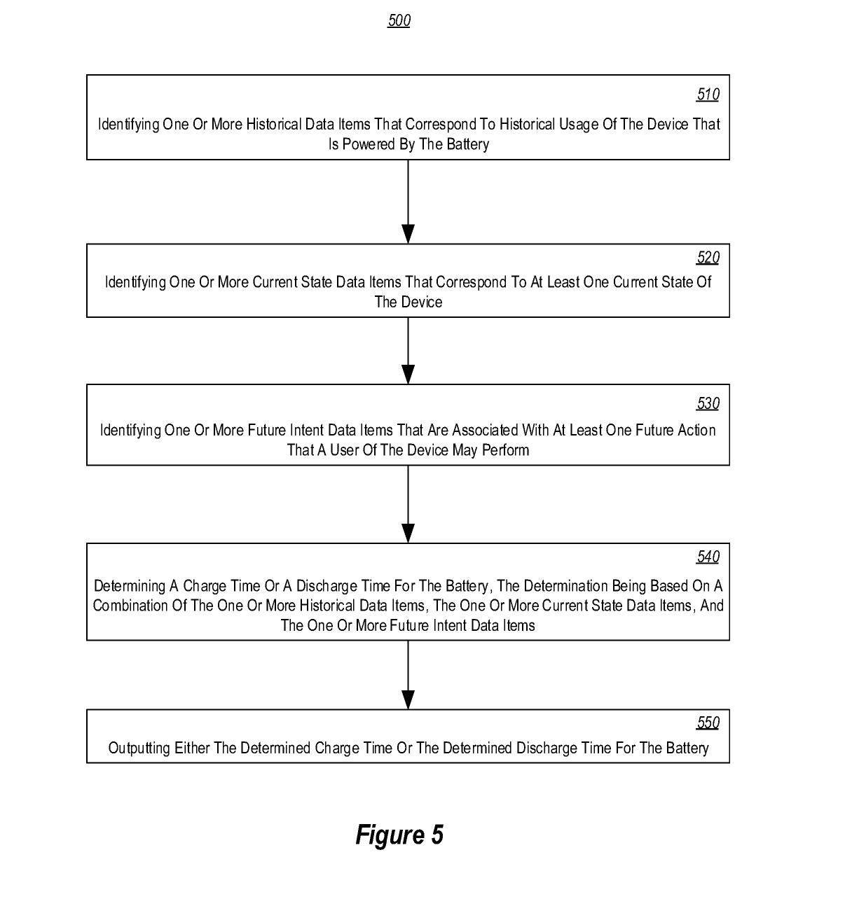

FIG. 5 illustrates a method 500 for determining a charge time or a discharge time for a battery of a device. The method 500 is described with frequent reference to the environment 200 of FIG. 2. The method may begin by identifying one or more historical data items that correspond to historical usage of the device that is powered by the battery (Act 510). In an example used throughout the description of the method 500, the battery analysis module 212 may access data gathered by the historical usage module 216, such as screen brightness, resource usage, the presence of a user at the computer system, and so forth at one or more particular previous time periods.

The method 500 also includes identifying one or more current state data items that correspond to at least one current state of the device (Act 520). In the continuing example, the battery analysis module may access data gathered by the current state module such as a current screen brightness, current resource usage, the current presence of a user at the computer system, and so forth. The method 500 may also include identifying one or more future intent data items that are associated with at least one future action that a user of the device may perform (Act 530). In the continuing example, the battery analysis module may access data gathered by the future intent module such as calendar information, identified usage patterns that indicate a likelihood of future usage, and so forth.

The method 500 may also include determining a charge time or a discharge time for the battery (Act 540). The determination may be based on a combination of the one or more historical data items, the one or more current state data items, and the one or more future intent data items. Accordingly, in the continuing example, the battery analysis module may access the previously described identified data (i.e., historical usage data, current state data, and future intent data) to determine either a battery charge or a battery discharge time. In some embodiments, the battery analysis module may also consider data tracked by the environmental factors module 220 and the aggregate usage tracking service 230 in the charge/discharge time determination.

The method 500 also includes outputting either the determined charge time or the discharge time for the battery (Act 550). In the continuing example, the battery analysis module may audibly output the amount of time to charge or discharge the battery. As described, the battery analysis module may also suggest one or more actions a user can take with respect to the determined battery charge/discharge time. For example, the battery analysis module may suggest using a battery saver mode to increase the battery discharge time or decrease the battery charge time. Additionally, the battery analysis module may output the improvement in charge/discharge time that will occur in response to the user performing the suggest action.

In this way, battery charge times and battery discharge times for a battery of a computer system may be more accurately and usefully determined/predicted by considering a combination of current state data of the computer system, historic usage data of the computer system, future intent data of a user of the computer system, environmental data associated with the user/computer system, and historical usage data associated with other computer systems that are similar to the computer system. Additionally, such data may also be used to determine suggested actions that a user can take to improve any given battery situation. Notably, a specific improvement that will occur in response to performing the suggested action may also be determined and outputted to the user such that the user can decide whether the improvement is worth taking the suggested action.

While some of the examples provided may limit a determination of either a discharge time or a charge time (as well as a determination of suggested user actions) to the data gathered by a limited number of the described modules/services (i.e., current state module, historical usage module, and so forth), such a determination may use any number of data items tracked by each individual module/service, as well as using data from any combination of services. For example, the battery analysis module may use every setting/state that is recorded by the current state module, historical usage module, future intent module, environmental factors module, and aggregate usage tracking service in order to determine a charge/discharge time for a given battery and/or suggested user actions. Alternatively, the battery analysis module may use less than all of the states/settings tracked by any given module/service and may further use less than all of the modules/services when making a charge/discharge time determination and/or suggested user actions.

Furthermore, while each of modules discussed herein have been described as separate modules, the principles described herein are not limited to such an environment. For instance, one module comprising any combination of hardware and software may perform all of the operations described herein as being performed by separate modules. Alternatively, many more modules than the ones described here may be used to perform the operations described herein.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system comprising:
one or more processors; and
one or more computer-readable storage media having stored thereon computer-executable instructions that are executable by the one or more processors to cause the computer system to determine a charge time or a discharge time for a battery of a device, the computer-executable instructions including instructions that are executable to cause the computer system to perform at least the following:
identify one or more historical data items that correspond to historical usage of the device that is powered by the battery;
identify one or more current state data items that correspond to at least one current state of the device;
identify one or more future intent data items that are associated with at least one future action that a user of the device may perform;
determine a charge time or a discharge time for the battery, the determination being based on a combination of the one or more historical data items, the one or more current state data items, and the one or more future intent data items; and
output either the determined charge time or the discharge time for the battery.

2. The computer system in accordance with claim 1, wherein the computer-executable instructions include instructions that are executable to cause the computer system to also perform at least one of the following:
output one or more suggested actions that are likely to decrease the determined charge time; and
output one or more suggested actions that are likely to increase the determined discharge time of the battery.

3. The computer system in accordance with claim 2, wherein the one or more historical data items include, for at least one given time period, at least one of a screen brightness, resource usage, battery capacity remaining and a battery saver state.

4. The computer system in accordance with claim 3, wherein the one or more current state data items include at least one of a current battery capacity remaining, a current screen brightness, current resource usage, and a battery saver state.

5. The computer system in accordance with claim 1, wherein at least one of the one or more future intent data items is identified based on a pattern of computer usage by the user.

6. The computer system in accordance with claim 1, wherein the one or more historical data items are weighted.

7. The computer system in accordance with claim 6, wherein the one or more historical items are weighted based on when the one or more historical data items occurred such that more recent historical data items are given more weight than older historical data items.

8. The computer system in accordance with claim 1, wherein one or more environmental factors are also considered in determining a charge time or a discharge time for the battery.

9. The computer system in accordance with claim 8, wherein the one or more environmental factors include at least one of a time of year and a time of day.

10. A method, implemented at a computer system that includes one or more processors, for determining a charge time or a discharge time for a battery of a device, comprising:
identifying one or more historical data items that correspond to historical usage of the device that is powered by the battery;
identifying one or more current state data items that correspond to at least one current state of the device;
identifying one or more future intent data items that are associated with at least one future action that a user of the device may perform;
determining a charge time or a discharge time for the battery, the determination being based on a combination of the one or more historical data items, the one or more current state data items, and the one or more future intent data items; and
outputting either the determined charge time or the discharge time for the battery.

11. The method in accordance with claim 10, further comprising outputting one or more suggested actions that are likely to decrease the determined charge time or output one or more suggested actions that are likely to increase the determined discharge time of the battery.

12. The method in accordance with claim 10, further comprising identifying a particular user of the device.

13. The method in accordance with claim 12, wherein the one or more identified historical data items and the one or more identified future intent data items are both associated with the particular user of the device.

14. The method in accordance with claim 10, further comprising identifying one or more historical data items associated with a second, different device that has similar specifications to the device.

15. The method in accordance with claim 14, further comprising using the one or more historical data items associated with the second, different device in the determination of either the charge time or the discharge time.

16. The method in accordance with claim 15, further comprising weighting the one or more historical data items associated with the second, different device such that the one or more historical data times associated with the second, different device are given less weight than the one or more historical data items and the one or more future intent items.

17. The method in accordance with claim 10, further comprising weighting the one or more historical items based on when the one or more historical data items occurred such that more recent historical data items are given more weight than older historical data items.

18. The method in accordance with claim 10, further comprising using one or more environmental factors in the determination of the charge time or the discharge time for the battery.

19. The method in accordance with claim 18, wherein the one or more environmental factors include at least one of a time of year and a time of day.

20. A computer program product comprising one or more hardware storage devices having stored thereon computer-executable instructions that are executable by one or more processors of a computer system to determine a charge time or a discharge time for a battery of a device, the computer-executable instructions including instructions that are executable to cause the computer system to perform at least the following:
identify one or more historical data items that correspond to historical usage of the device that is powered by the battery;
identify one or more current state data items that correspond to at least one current state of the device;
identify one or more future intent data items that are associated with at least one future action that a user of the device may perform;
determine a charge time or a discharge time for the battery, the determination being based on a combination of the one or more historical data items, the one or more current state data items, and the one or more future intent data items; and
output either the determined charge time or the discharge time for the battery.
